(19) United States
(12) Patent Application Publication
(10) Pub. No.: US 2003/0032430 A1
(43) Pub. Date: Feb. 13, 2003

(54) Method and system for performing fast access handoff in mobile telecommunications system

(75) Inventor: Yong-Hwan Lee, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/158,532

(22) Filed: May 30, 2002

(30) Foreign Application Priority Data
Aug. 8, 2001 (KR) 2001-47641

(51) Int. Cl. H04Q 7/20

(52) U.S. Cl. 455/436; 455/434; 455/437; 455/450

(57) ABSTRACT

The present invention relates to a method and system for performing a handoff in a mobile telecommunications system. Particularly, the present invention provides a method of performing an access handoff in which a mobile station (MS) receives an extended channel assignment from a new base station without reception of overhead messages from the new base station, thereby allowing a traffic channel to be quickly assigned and providing a faster call connection for a user.

### PRIORITY

This application claims priority to an application entitled “Method and System for Performing Fast Access Handoff in Mobile Telecommunications System”, filed in the Korean Industrial Property Office on Aug. 8, 2001 and assigned Serial No. 2001-47641, the contents of which are hereby incorporated by reference.

### BACKGROUND OF THE INVENTION

1. Field of the Invention

The present invention relates to a handoff in a mobile telecommunications system, and more particularly, to a method and system for performing a fast access handoff in a mobile telecommunications system in which a mobile station is directly assigned a channel without receiving overhead messages, as in the case for performing an access handoff with requiring no access information, thereby providing a faster call connection for a user and preventing the user from suffering inconvenience in making a call.

2. Description of the Related Art

Generally, as shown in FIG. 1, a handoff in a mobile telecommunications system is a procedure where a base station (BS) providing service to a mobile station (MS) 112 changes from a current base station 101 to a new base station 103 while maintaining a wireless link between the MS 112 and the base station 101 or 103 and not disconnecting the link while the MS 112 moves into a new cell 123 outside the boundary of a current cell 121. The above handoff may include, for example, a soft handoff, CDMA to CDMA hard handoff, CDMA to analog handoff, softer handoff, idle handoff, etc. The procedure of performing this handoff is disclosed in publications associated with mobile communication and supporting IS-95B. Therefore, a detailed description will be omitted. If an MS transmits or receives an outgoing call or incoming call and moves over a boundary of its current cell before the call is set up, the MS receives originating messages from BSs, analyzes pilot offsets and pilot strength, as shown in FIG. 2, of the originating messages, and predicts its moving path. Then, one of the BSs allocates its resources and transmits an acknowledgement message (BS-ACK Message) or channel assignment message to the MS, thereby raising the call setup rate. This is known as an access handoff method. In the construction of the MS as shown in FIG. 3, an application program 213 is run by a message control processor 201 to process the messages from the BSs for implementing the access handoff method.

There are two technologies for implementing the access handoff method, namely, an access handoff and an access probe handoff.

The access handoff is classified into an in-BS access handoff, inter-BS access handoff and combination of the in-BS and inter-BS access handoff. The in-BS access handoff is a technique of assigning an extended channel in a BS to set up a call. The inter-BS access handoff is a technique of assigning channels to two or more BSs. The access probe handoff occurs while an MS attempts access in a page response substate. In this handoff, if an MS transmits an origination call to a BS and receives no BS_ACK message from the BS, it then re-transmits the origination call to the BS. The access probe handoff is performed in the same manner as the access handoff with the exception that the BS transmits the BS_ACK message to the MS upon receiving the origination call retransmitted from the MS during its call setup operation. An example of the access handoff method a BS requires fundamental information of a system. In the conventional access handoff method as shown in FIG. 4, an MS must receive overhead messages, as signaling messages for system information, access information and environment information, upon making a transition to an idle state. Though not shown specifically, the overhead messages may be, for example, a system parameters message, access parameters message, extended system parameters message, neighbor list message, extended neighbor list message, general neighbor list message and CDMA channel list message. The MS may further receive a private neighbor list message, user zone identification message, extended CDMA channel list message, global service redirection message or an extended global service redirection message, if necessary. Of course, it is not always necessary for the MS to receive the global service redirection message, CDMA channel list message, extended global service redirection message and extended CDMA channel list message so as to perform an access handoff. However, as shown in FIG. 4, the MS has to receive overhead messages from a new BS (NBS) in every case and it takes at least 1.28 seconds to receive all of the above overhead messages. For this reason, the conventional access handoff method causes a delay in the call setup being inconvenient for a user when making a call. Further, with growth of demand for MSs, the number of BSs and the number of the channels assignable to each BS has also grown, and therefore there is a problem that handoffs frequently occur even within a short time.

### SUMMARY OF THE INVENTION

It is, therefore, an object of the present invention to provide a method and system that allow a mobile station to be assigned a channel while receiving no overhead messages in performing an access handoff with no access requirements, thereby providing a faster call connection for a user.

It is another object of the present invention to provide a method for eliminating a delay in traffic channel assignment in performing an access handoff in a mobile telecommunication system.

In accordance with an aspect of the present invention, the above and other objects can be accomplished by the provision of a method for performing a fast access handoff of a mobile station in a mobile telecommunications system, including the steps of a) allowing the mobile station to detect a strength of a pilot signal while moving to a boundary between a current base station and a new base station, the pilot signal being generated by the new base station; b) allowing the mobile station to check information and environmental conditions of the new base station generating the pilot signal in step a) to determine whether the new base station is adjacent to the current base station; c) if the new base station is determined to be adjacent to the current base station in step b), allowing the mobile station to recognize that the new base station belongs to an active set and to store the information of the new base station; d) if the information is stored in step c), allowing the mobile station to receive an extended channel assignment message from the new base station without receiving overhead messages from the new base station such that the mobile station is assigned a traffic channel based on the extended channel assignment message; and e) if the traffic channel is assigned in step d), allowing the mobile station to determine whether information of a system having the current base station has been changed, and allowing the mobile station to receive new information of the system if the information of the system has been changed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating an example of a conventional operation of a mobile station (MS) in a mobile communication network;

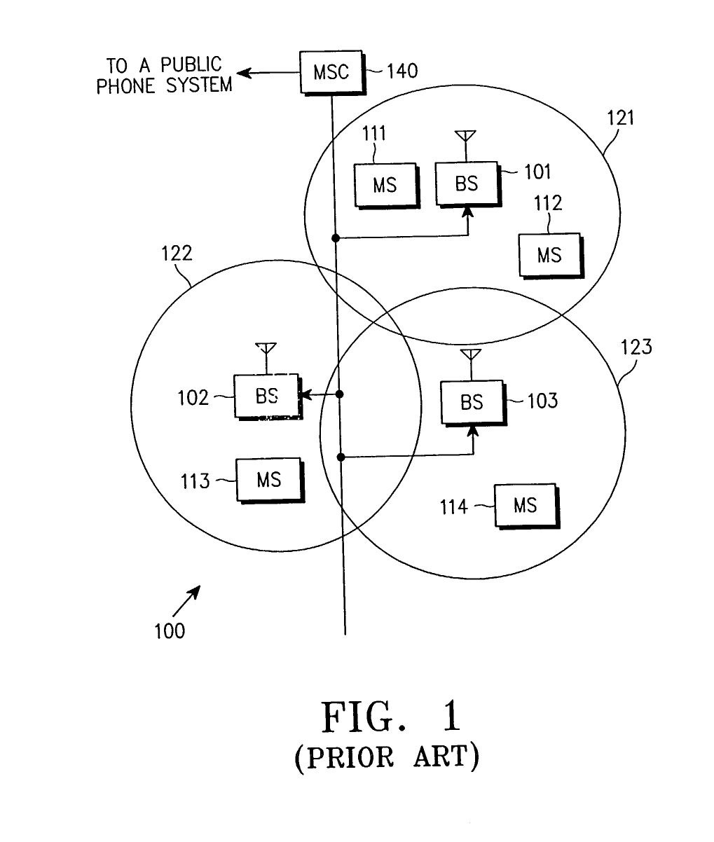

FIG. 2 is a graph showing variations in strength of pilot signals, which an MS receives from base stations, based on sudden variations in field intensity;

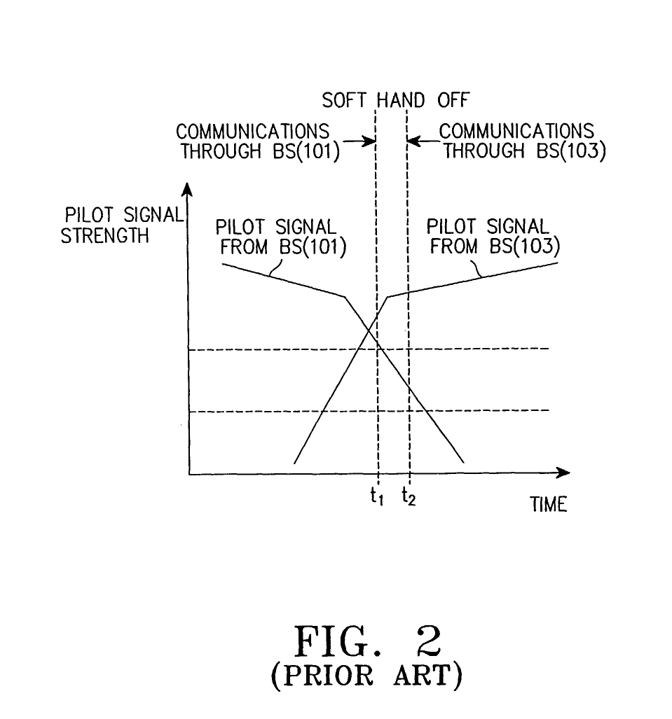

FIG. 3 is a block diagram schematically showing the construction of the MS of FIG. 1;

FIG. 4 is a sequence diagram showing a procedure of performing a conventional access handoff;

FIG. 5 is a sequence diagram illustrating a procedure of performing a fast access handoff according to the present invention;

FIG. 6 is a flowchart illustrating a procedure of performing a fast access handoff according to the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted since they would obscure the invention in unnecessary detail.

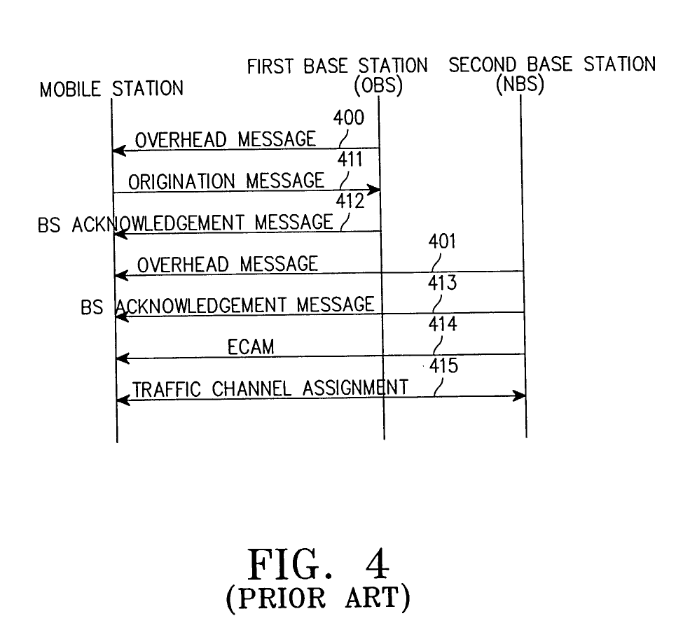

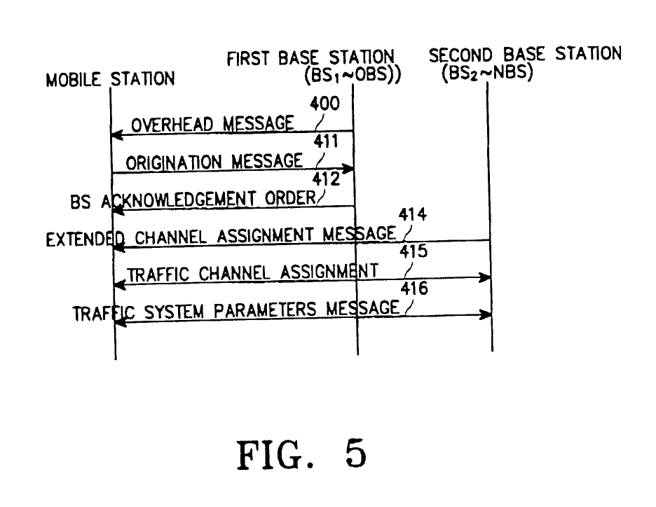

FIG. 5 is a sequence diagram illustrating a procedure of performing a fast access handoff according to the present invention. As illustrated in FIG. 5, the MS is configured to, during a transition from a first base station, or a current base station (BS1=OBS), to a second base station, or a new base station (BS2=NBS), directly receive an extended channel assignment message (ECAM) 414 from the BS2 without reception of overhead messages from the BS2 such that it is assigned a traffic channel 415 from the BS1 and receives a traffic system parameters message 416 from the BS1. By doing so, it is possible to perform a fast access handoff reducing the delay time due to the reception of the overhead messages, unlike the example of FIG. 4.

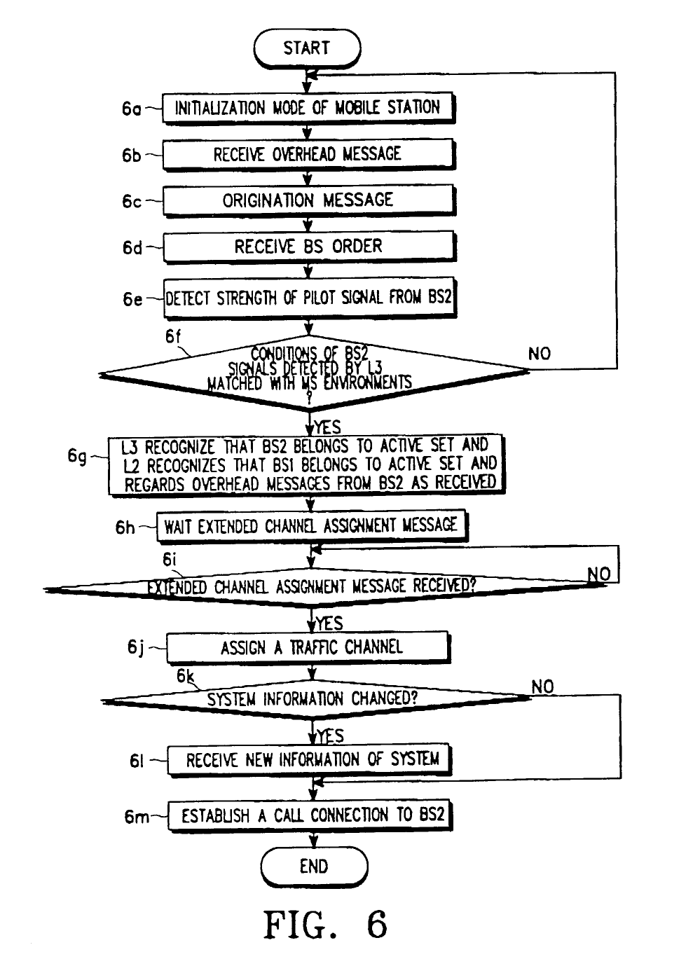

FIG. 6 is a flowchart illustrating a procedure of performing a fast access handoff according to the preferred embodiment of the present invention.

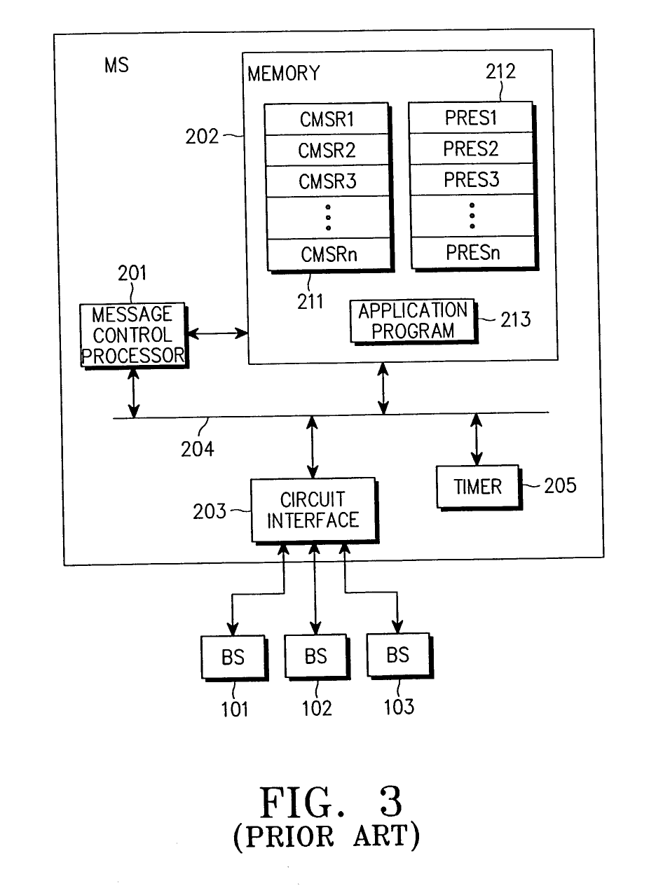

Before a detailed description is given of the present invention, a brief description will be given of a layer 2 (L2), layer 3 (L3) and searcher, all of which are associated with the present invention and included in the application program 213 of FIG. 3.

The L2 is a determination module which determines whether there is an error in a processed message, and transmits an acknowledgement message if there is no error in the processed message. The L2 sorts out duplicate messages and performs an address matching operation of determining whether a destination address of a termination call, that arrived at the MS, matches an address of the MS.

The L3 is a control module which controls the entire operation of the MS as a main controller. For example, the L3 receives the values of signaling messages to be transmitted from corresponding tasks, fills the signaling messages with the received values and then transmits the resulting messages. The L3 further sends received messages to corresponding tasks.

The searcher is a detection module which searches for a system and acquires it. The searcher further performs an operation of detecting pilot signals from neighbor BSs during a handoff.

Referring back to FIG. 6, assuming that an MS is currently located near a boundary between cells of a first BS (BS=OBS) and a second BS (BS2=NBS), and an access handoff between the BSs is just occurring, the MS is in an initialization mode at a current position in a cell of the BS1 (Step 6a). Then, the MS receives overhead messages 400 from the BS1. When the MS receives all the overhead messages 400, the MS makes a transition to an overhead reception completion (OVHD-MSG-OK) state. At this time, the MS enters an idle state (Step 6b). When a “send” key of the MS is pushed, an origination message 411 is transmitted from the MS to the BS1. Then, the MS makes a transition from the idle state to an access state (Step 6c). Thereafter, if the BS1 normally receives the origination message 411 from the MS, the BS1 then generates a BS acknowledgement order (BS-ACK-ORDER) signal 412 and the MS receives the BS-ACK-ORDER signal 412 from the BS1 (Step 6d). An access handoff can occur under the present status that the MS is in the access state and has received the BS-ACK-ORDER signal 412. The MS detects the strength of a pilot signal generated by BS2. The MS can more easily detect the pilot strength if it is larger than the pilot strength generated by the BS1 (Step 6e).

Then, the MS checks information of the BS2 in order to determine whether the BS2 is located in a current neighbor set of the MS and examines all of the environmental conditions of the BS2 (Step 6f). If the information is invalid, namely, the BS2 is not located in the neighbor set, the MS makes a transition to the initialization state. However, if the information is valid, namely, the BS2 is located in the neighbor set, then the control module (L3) recognizes that the BS2 belongs to an active set and stores the valid information of BS2. On the other hand, the determination module (L2) recognizes that not the BS2, but the BS1, still belongs to the active set and, therefore, does not receive overhead messages from the BS2. Namely, the MS ignores all of the overhead messages from the BS2, since it recognizes that there is no change of a BS (or determines that a handoff did not occur) in the OVHD-MSG-OK state (Step 6g). Thereafter, the MS waits for the ECAM 414 to be received from the BS2 (Step 6h). If the ECAM is determined to be received (Step 6i), then BS1 assigns the MS a traffic channel (Step 6j). After the traffic channel is assigned, the BS1 determines whether BS information has been changed (Step 6k). If BS information has been changed, then the MS receives new information of a system (ITSPM=In Traffic System Parameters Message) from the BS1 and if not, it does not receive the new information. The BS1 transmits the ITSPM to the MS if BS1 information and BS2 information are not the same. The reason for reception of the ITSPM is that the MS must have information of the BS2 to perform a handoff in a speech state. Therefore, the MS receives and processes the ITSPM (Step 61). Then, the MS establishes a call connection to the BS2 over the traffic channel (Step 6m).

As apparent from the above description, the present invention provides a method and system that allow an MS to be assigned a channel while receiving no overhead messages in performing an access handoff with no access requirements and that provide a fast call connection for a user, thereby eliminating a user's complaint caused by delays in traffic channel assignment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for performing a fast access handoff between a first base station in which a mobile station is currently located and a second base station to which the mobile station is to move, comprising a mobile station configured to, during a transition from the first base station to the second base station, receive an extended channel assignment message from the second base station without receiving overhead messages from the second base station, the mobile station being assigned a traffic channel based on the extended channel assignment message, and then receiving a traffic system parameter message from the first base station.

2. A method for performing a fast access handoff of a mobile station in a mobile telecommunications system, comprising the steps of:
a) allowing the mobile station to detect a strength of a pilot signal while moving to a boundary between a current base station and a new base station, the pilot signal being generated by the new base station;
b) allowing the mobile station to check information and environmental conditions of the new base station generating the pilot signal in step a) to determine whether the new base station is adjacent to the current base station;
c) if the new base station is determined to be adjacent to the current base station in step b), allowing the mobile station to recognize that the new base station belongs to an active set and to store the information of the new base station;
d) if the information is stored in step c), allowing the mobile station to receive an extended channel assignment message from the new base station without receiving overhead messages from the new base station such that the mobile station is assigned a traffic channel based on the extended channel assignment message; and
e) if the traffic channel is assigned in step d), allowing the mobile station to determine whether information of a system having the current base station has been changed, allowing the mobile station to receive new information of the system if the information of the system has been changed.

3. A method for performing a fast access handoff which occurs between a first base station in which a mobile station is currently located and a second base station to which the mobile station is to move, comprising the steps of:
a) allowing the mobile station to receive an extended channel assignment message from the second base station without receiving overhead messages from the second base station during passage through a boundary between the base stations while allowing the mobile station to receive overhead messages from the first base station, transmit an origination message to the first base station and receive a base station acknowledgement message from the first base station;
b) assigning the mobile station a traffic channel based on the extended channel assignment message; and
c) allowing the mobile station to receive new information of a system having the first base station according to whether current information of the system has been changed and then establish a call connection to the second base station over the traffic channel.

4. The method as set forth in claim 3, wherein step a) further includes the steps of:
a-1) allowing the mobile station to detect a strength of a pilot signal generated by the second base station;
b-2) allowing the mobile station to check information and environmental conditions of the second base station to determine whether the second base station is adjacent to the first base station;
c-3) if the second base station is determined to be adjacent to the first base station in step b-2), allowing the mobile station to recognize that the second base station belongs to an active set and store the information of the second base station; and
d-4) if the information of the second base station is stored in step c-3), allowing the mobile station to receive no overhead messages from the second base station.
